(19) United States
(12) Patent Application Publication
(10) Pub. No.: US 2014/0220536 A1
(43) Pub. Date: Aug. 7, 2014

(54) Computer Implemented Methods, Systems and Products for Team Based Learning

(71) Applicant: Virginia Commonwealth University, Richmond, VA (US)

(72) Inventors: Alan Dow, Henrico, VA (US); Peter Boling, Richmond, VA (US); Chris Stephens, South Chesterfield, VA (US); John Priestley, Richmond, VA (US); Joel Browning, Henrico, VA (US); Meenu Tolani, Lincolnwood, IL (US)

(73) Assignee: Virginia Commonwealth University, Richmond, VA (US)

(21) Appl. No.: 14/175,007

(22) Filed: Feb. 7, 2014

Related U.S. Application Data
(60) Provisional application No. 61/762,152, filed on Feb. 7, 2013.

(51) Int. Cl. G09B 7/00

(52) U.S. Cl. CPC G09B 7/00
USPC 434/350

(57) ABSTRACT

Computer implemented methods, systems, and products uses learning cycles of individual and group work to emphasize the importance of collaborative behaviors and demonstrate the values of effective team work on outcomes. The computer implemented methods, systems, and products relate to team based learning with individual and group assessment for addressing a project or a problem, particularly to promote interaction between participants. In the computer implemented learning cycle, a team works as individuals and then as a group to determine responses to an overall project or problem. In addition to assessing the performance of the individuals and the determined individualized and overall responses, the computer implemented methods, systems, and products track the progress and activity of individuals and the team. Through the cycle of learning activities, individuals demonstrate personal responsibility, collaborative orientation, communication skills, conflict management, and problem solving.

This patent application is based on and claims filing priority from co-pending U.S. Provisional Application Ser. No. 61/762,152, filed on Feb. 7, 2013.

### BACKGROUND OF THE INVENTION

It is known in the context of healthcare that a patient's health outcomes and access to care requires high functioning interdisciplinary teams supported by information technology, including electronic health records (EHRs) that span a wide variety of settings of care. To support such teams, health professions education must train practitioners with improved skills in interprofessional practice and clinical informatics. Currently, competencies in these areas are poorly integrated into formal educational programs. Accordingly, there is a need to find effective approaches to instruction and assessment for interprofessional education that are robust and have the capacity to engage large numbers of learners on small sized teams. Accomplishing this goal has been a challenge for both logistic and technical reasons.

Because interprofessional practice varies based on the context of healthcare, educators must prepare students to be effective collaborators across a range of clinical settings using broadly applicable principles for team function. More urgent interprofessional care (e.g., heart surgery), characterized by contemporaneous interaction and a strong hierarchy for leadership, has been called “collaborative.” Less urgent settings, featuring a more asynchronous approach with shared leadership and less structured authority, have been termed as “coordinative.” Collaborative care has been taught effectively using modalities such as team training with or without simulation. For purposes of training students to function in a transforming system of care, and to include longitudinal care models in training, educators need to provide specific training experiences in applicable environments that can build and ensure competency.

Although EHRs in the health care context are centrally important to coordinating care through improved quality and decreased errors, training in the use of EHRs has not been well integrated into health professions education. Previous educational interventions related to EHRs have been limited to classroom training, computer-based modules, and record reviews with feedback which is labor-intensive. While EHRs are beginning to be integrated into simulations, educators have failed to utilize EHRs to train asynchronous coordination. To train practitioners capable of surmounting the challenges facing healthcare, educators need better platforms to teach and assess the behaviors needed for successful interprofessional coordinative care.

Some of the major barriers facing interprofessional education are logistical, such as student scheduling and room capacity. While a few programs created interprofessional learning wards where students of different disciplines collaborate on care, these efforts are resource intensive. There is a need to find an efficient way to teach and assess large numbers of learners and to overcome the structural issues inherent in large interprofessional education experiences.

Despite the large number of interprofessional education initiatives being implemented, few programs have shown benefits beyond changes in learner attitudes and knowledge. Accordingly, one of the drawbacks of current approaches is that any record of student behaviors cannot be quantified over time in order to measured specific knowledge and demonstrate how knowledge and attitudes are translated to actions in the care of patients. Accordingly, there is a need to address the problems in the prior art.

### SUMMARY OF THE INVENTION

The present invention is provided in view of the above problems and an object of the present invention is to provide computer implemented methods, systems, and/or products for team based learning for addressing a project or a problem.

Exemplary embodiments of the present invention are methods that include the steps of and systems and/or products that perform the steps of: providing, using a computer or network of computers, a description of an overall project or problem to a plurality of groups, each of the groups including one or more group members, and each of the groups having a role for the overall project or problem, such that the role is different for each of the groups; distributing, using the computer or network of computers, different role specific information to each of the groups; distributing, using the computer or network of computers, questions or scenarios to each of the groups, the questions or scenarios pertaining to the role specific information and to the overall project or problem; permitting the one or more group members in each of the plurality of groups to input to an electronically accessible repository one or more summary inputs of the role specific information provided to the group; obtaining, using the computer or network of computers, inputted individualized responses to the questions or scenarios from each of the group members of each of the groups; obtaining, using the computer or network of computers, inputted overall group responses to the questions or scenarios, the inputted overall responses being supplied on behalf of the plurality of groups; and assessing, using the computer or network of computers, the inputted individualized responses and the inputted overall group responses.

Additional exemplary embodiments of the invention are methods, systems, and/or products such that the step of assessing compares one or more inputted overall group responses to one or more stored responses to the questions or scenarios, compares one or more inputted individualized responses to one or more stored responses to the questions or scenarios, obtains performance assessments of the one or more group members on the individualized responses, obtains performance assessments of group members on group responses, tallies a frequency of each of the inputted group responses, and tallies a frequency of each of the inputted individual responses.

Further exemplary embodiments of the invention are methods that include the steps of and systems and/or products that perform the steps of comparing inputted individualized responses to inputted overall responses, such that the step of comparing is performed multiple times.

Preferred embodiments of the invention are methods that include the steps of and systems and/or products that perform the steps of permitting electronic communications between each of the groups, saving the electronic communications; and evaluating the frequency and type of electronic communications using the computer or network of computers.

In exemplary embodiments of the invention, methods include the steps of and systems and/or products perform the steps of repeating one or more of distributing different role specific information to each of the groups or distributing questions or scenarios to each of the groups, and repeating each of obtaining inputted individualized response, obtaining inputted overall responses, and assessing the inputted individualized responses and the inputted overall responses.

In yet another preferred embodiment, the methods include the steps of and systems and/or products perform the steps of preventing sharing of the different role specific information on the electronically accessible repository or by electronic transmission without being summarized as the one or more summary inputs.

In still an additional preferred embodiment, the methods include the steps of and systems and/or products perform the steps of distributing, using the computer or network of computers, progress reports of the one or more group members to overseers of the process.

### BRIEF DESCRIPTION OF THE DRAWINGS

FIG. 1 is an illustrative exemplary architecture of a network of computers, in which embodiments of the present invention may be implemented.

FIG. 2 illustrates a flow diagram of one embodiment for a method for team based learning with individual and group assessment for addressing a project or a problem.

FIG. 3 provides a more detailed illustration of some of the steps of the method illustrated in FIG. 2.

FIG. 4 provides a more detailed illustration of some of the steps of the method illustrated in FIG. 2.

FIG. 5 is a block diagram illustrating a conventional computer system 400 within which a set of instructions, for causing the machine to perform any one or more of the methodologies and operations discussed herein, may be executed.

FIG. 6 shows the distribution of individual scores on the questions supplied to the groups from data obtained from a testing experiment of the present invention.

FIG. 7 is a histogram of exemplary data from a testing experiment of the invention, particularly it illustrates scores by medical students who participated in the testing experiment.

### DETAILED DESCRIPTION OF THE INVENTION

It is understood that specific embodiments are provided as examples to teach the broader inventive concept, and one of ordinary skill in the art can easily apply the teachings of the present disclosure to other methods and systems. Also, it is understood that the methods and systems discussed in the present disclosure include some conventional structures and/or steps. Since these structures and steps are well known in the art, they will only be discussed in a general level of detail. Furthermore, reference numbers are repeated throughout the drawings for the sake of convenience and example, and such repetition does not indicate any required combination of features or steps throughout the drawings.

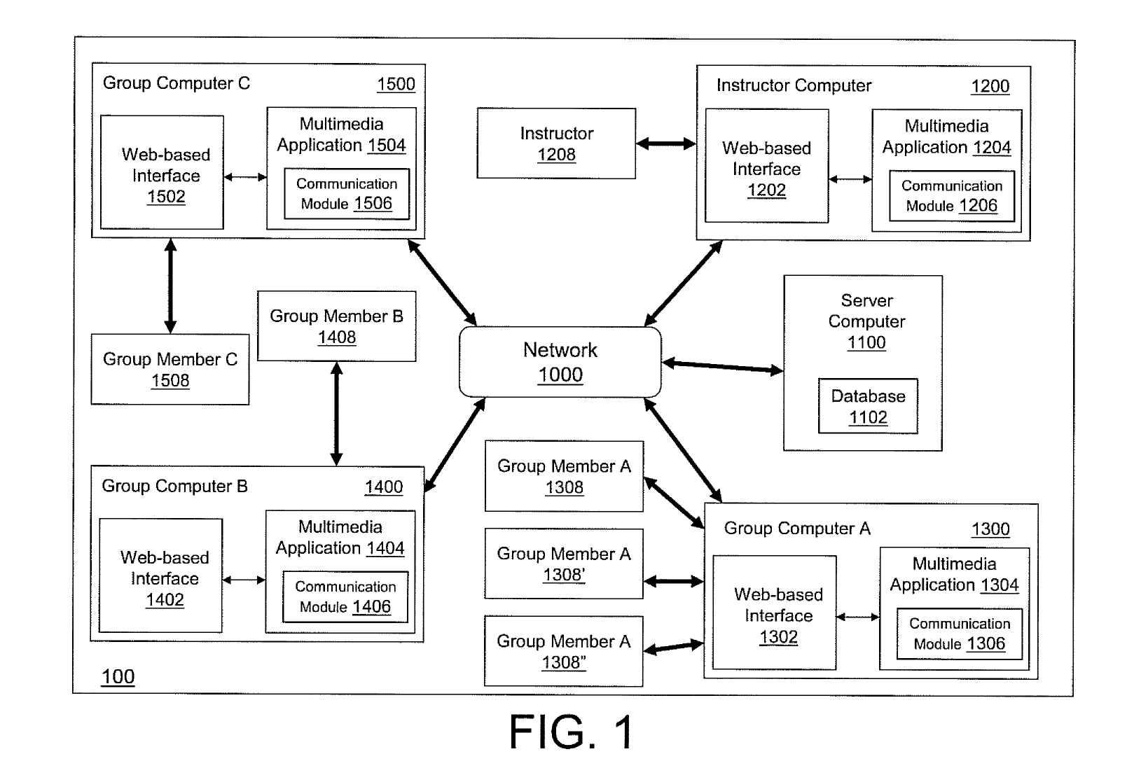

FIG. 1 is an illustrative exemplary architecture of a network of computers 100, in which embodiments of the present invention may be implemented. The present invention is not limited to implementation on a network of computers, but it may also be implemented on a computer.

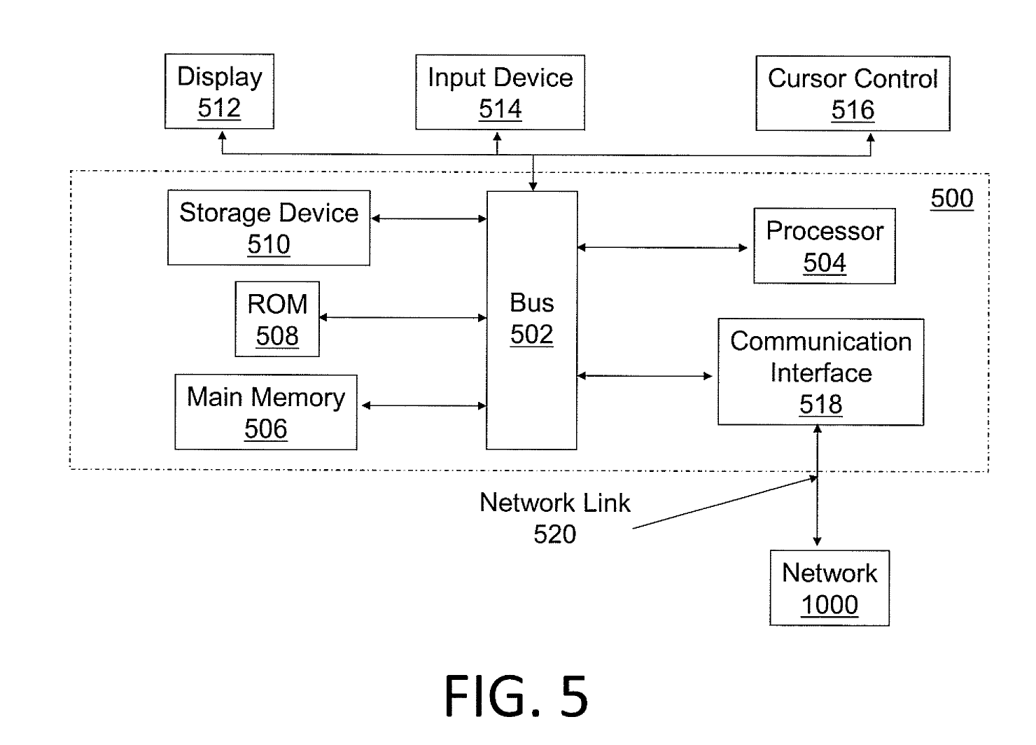

In one embodiment, the network of computers 100 includes a server computer 1100, an instructor computer 1200, and a plurality of group computers 1300, 1400, 1500. The server computer 1100, the instructor computer 1200, and the plurality of group computers 1300, 1400, 1500 may be interconnected via a network 1000, such as a public network (e.g., Internet), a private network (e.g., Ethernet or a local area network (LAN)), or a combination thereof. All of the computers included in the network of computers 1000 may be or include any or all the components of computer system 500 as discussed in detail below with respect to FIG. 5.

The plurality of group computers is illustrated by way of example by group computer A 1300, group computer B 1400, and group computer C 1500. However, the number of group computers connected to the network 1000 is not restricted, and may depend on the number of total groups on a team and/or the number of total group members on all the groups. Each of the group computers 1300, 1400, 1500 is operated by one or more group members of the team. As illustrated by way of example with group A, there may be one or more group members A 1308, 1308′, 1308″ with access to operate the group computer A 1300, and each of the group members A 1308, 1308′, 1308″ may have their own computer, and each of these may independently function as group A computer 1300. While groups B and C are depicted to include a group member B 1408 and group member C 1508, respectively, groups B and C may include a plurality of group members as illustrated with group A. Despite not being shown, the implementation of the present invention permits each of the one or more group members A 1308, 1308′, 1308″ to utilize their own individual computer as the group computer A 1300 in order to, for example, interact and communicate with other group members, other groups, and the network of computers 400 in general. This functionality extends to any and all group members of groups B and C as well.

Each of the group computers 1300, 1400, 1500 includes a web-based interface 1302, 1402, 1502 that may be used, for example, to logon to the network and conduct subsequent interactions. Login and access functions for the group computers 1300, 1400, 1500 may be protected by password or by other security measures. For example, the web-based interface 1302, 1402, 1502 permits the group members to access, interact with, and retrieve information from the server computer 1100 and/or the instructor computer 1200 through the network 1000.

Each of the web-based interfaces 1300, 1400, 1500 includes a multimedia application 1304, 1404, 1504 running on each of the group computers 1300, 1400, 1500. The multimedia applications 1304, 1404, 1504 provide a platform to create applications that may be displayed as interactive multimedia content via the web-based interfaces 1302, 1402, 1502.

A communication module 1306, 1406, 1506 is provided as part of the multimedia application 1304, 1404, 1504, permitting electronic communication between each of the group computers 1300, 1400, 1500. For example, the communication modules 1306, 1406, 1506 may contain a message board for asynchronous discussion between the groups. The message board provides a web-based forum for all group members 1308, 1408, 1508 to post questions, answers, and/or comments that is accessible to all the groups on the team. Please note that such functionality for electronic communication between the groups may be facilitated through various well-known means and is not limited to a message board.

The instructor computer 1200 includes a web-based interface 1202, a multimedia application 1204, and a communication module 1205. These components may include the same capabilities and functions of the components described above with respect to group computers 1300, 1400, 1500. The group computers 1300, 1400, 1500 may electronically communicate with the instructor computer 1200 via its communication module 1206 and each of their respective communication modules 1306, 1406, 1506. The instructor computer 1200 may provide the instructor 1208 with the ability to input, to output and to edit any information into the server computer 1100 and or information already stored in the server computer 1100. For example, the instructor 1208 may input or edit the roles assigned to each of the groups of the team. The instructor 1208 may merely function as a proctor or coordinator.

The server computer 1100 includes an electronically accessible repository, which is illustrated by example as database 1102. The server computer 1100 is designed to allow the definition, creation, querying, update, and administration of the database 1102. The database 1102 stores all the information relevant to the overall project or problem. By way of example and not limitation, the information stored in database 1102 of the server computer 1100 may include a description of the overall project or problem, the roles of each of the groups on the team, the questions or scenarios, the individualized responses, and the inputted overall responses.

The server computer 1100 and its database 1102 may be accessed by the instructor 1208 and a group member 1308, 1408, 1508 to input or output any information via their respective web-based interface 1202, 1302, 1402, 1502. The server computer 1100 may also function to assess any information stored in its database 1102. For example, the server computer 1100 may compare the individualized responses supplied by each group member to the overall responses supplied by each group.

The server computer 1100 and the instructor computer 1200 are depicted in the exemplary architecture as separate computers. However, the server computer 1100 and the instructor computer 1200 may be one single computer and/or may be handled by a network of computers. Further, the server computer 1100 may require little to no human involvement in order to administer and/or perform any operations and/or functions in the network of computers 100.

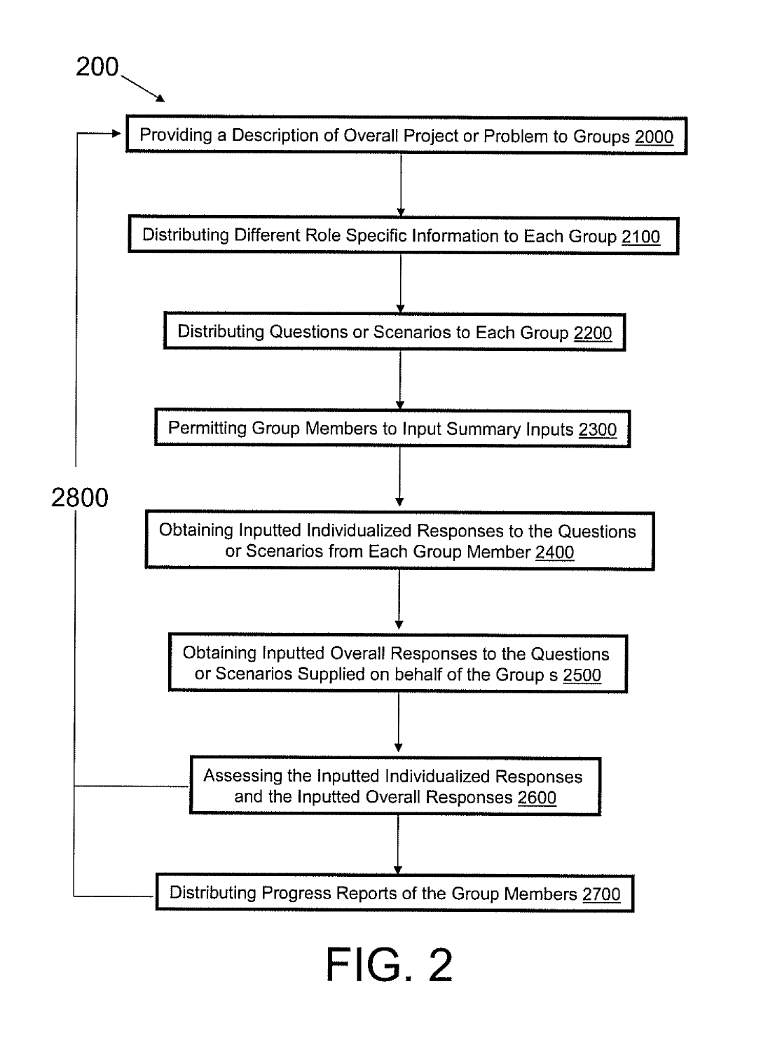

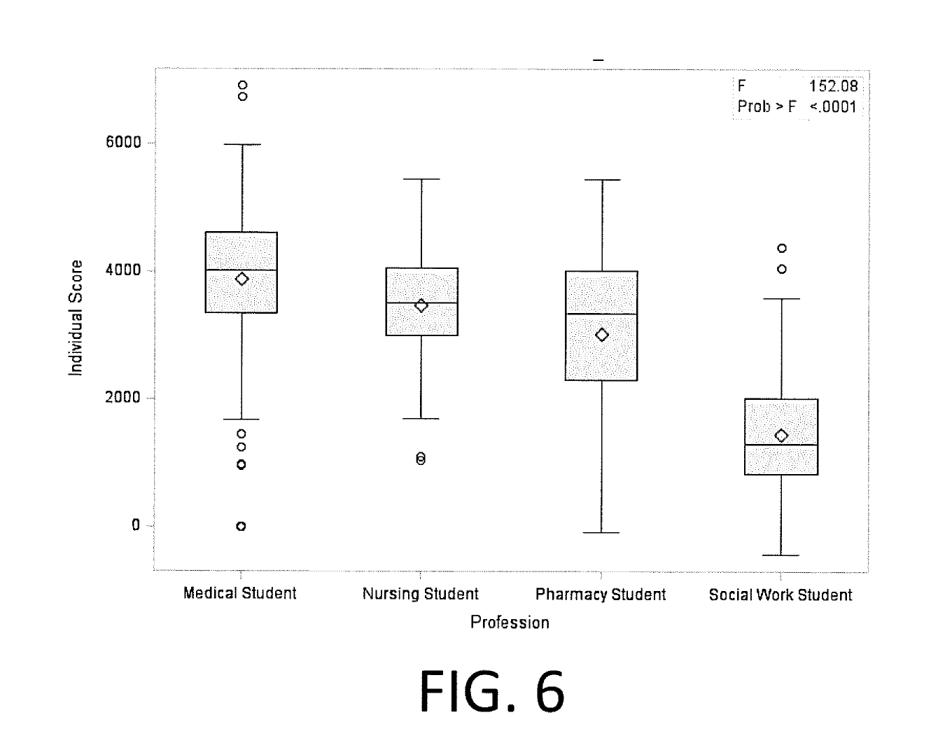

FIG. 2 illustrates a flow diagram of one embodiment for a method 200 for team based learning with individual and group assessment for addressing a project or a problem. Some or all the steps of the method 200 may be performed by processing logic that may comprise hardware (e.g., circuitry, dedicated logic, programmable logic, microcode, etc.), software (such as instructions run on a processing device), or a combination thereof. See FIGS. 5 and 6 below for a more detailed description. In a preferred embodiment, the steps of method 200 may be performed by a computer or a network of computers 100, which is described in greater detail above with respect to FIG. 1. Please note that any reference to the exemplary architecture of the network of computer 100 is provided for simply for purposes of clarity. However, implementation of the method 200 is not limited to this exemplary embodiment.

The method 200 preferably uses cycles, as indicated by arrow 2800, of individual and group work to emphasize the importance of collaborative behaviors and demonstrate the value of effective team work on outcomes. The method 200 includes providing a description of an overall project or problem to a plurality of groups, each group may have one or more group members (block 2000). The various different groups form a team working together to address the project or problem. There is no limit to the number of groups forming a team or the number of group members in a group. Further, it is understood that the methods, systems and products described herein may support any number of teams. Each group is assigned a specific role within the team. The assigned role for the project or problem is different for each of the groups on the team.

At block 2100, the role specific information is distributed to each of the groups on the team. The role specific information is based on the assigned roles of each of the groups, which may be determined by the instructor. The roles may be assigned based on various objectives, including, but not limited to, the educational background of each of the groups on the team. By way of example and not limitation, the server computer 1100 may distribute the role specific information to each of the groups by querying the database 1102 and transmitting the appropriate outputs to each group computer 1300, 1400, 1500 through the respective web-based interface 1302, 1402, 1502.

The method 200 further distributes questions or scenarios to each of the group members (block 2200). The distributed questions or scenarios pertain to the role specific information distributed to the groups and/or to the overall project or problem. In a preferred embodiment, the questions or scenarios are content-based questions based on the summary inputs inputted by each of the group members (see block 2300) and/or on system-supplied questions stored in the database 1102 of the server computer 1100 that may be developed by the instructor 1208.

The distributed role specific information is summarized by each of the group members as summary inputs. At block 2300, each of the group members are permitted to input to an electronically accessible repository their summary inputs of the role specific information provided to the group. The method 200 prevents sharing of the different role specific information provided to each of the groups to the other groups without first being summarized. The role specific information is prevented from being inputted into the electronically accessible repository and from being transmitted by electronic transmission without being summarized as a summary input. This can be achieved using copy protection or other techniques. By preventing such sharing, the groups must build trust between each other leading to a better performing team.

The method 200 includes obtaining inputted individualized responses to the question or scenarios. Each of the group members of each of the groups inputs individualized responses. These individual responses may be formulated by each of the group members with use of all the summary inputs inputted into the electronically accessible repository. As described in greater detail below, the summary inputs may be collected as group-compiled case representations for use by each of the groups.

At block 2500, all the groups input overall responses to the questions or scenarios as a team. These questions or scenarios are the same questions or scenarios responded to individually by each group member. To facilitate formulation of the overall responses, the method 200 may include permitting electronic communication between each of the groups, which may be saved for later access and evaluation. In a preferred embodiment, the overall responses are obtained only after a collaborative discussion between the groups.

The method 200 includes the step of assessing the inputted individualized responses and/or the inputted overall responses (see block 2600). The assessing of the inputted individualized responses may compare each of the responses to a stored response to the questions or scenarios. The stored response may be an ideal answer or solution to the question or scenario. Likewise, the assessing of the inputted overall responses may also be compared to the stored responses. In addition, the inputted individualized responses may be compared to the corresponding inputted individual group responses. For example, the server computer 1100 may store the stored answers in its database 1102, and perform the assessment of both the inputted responses.

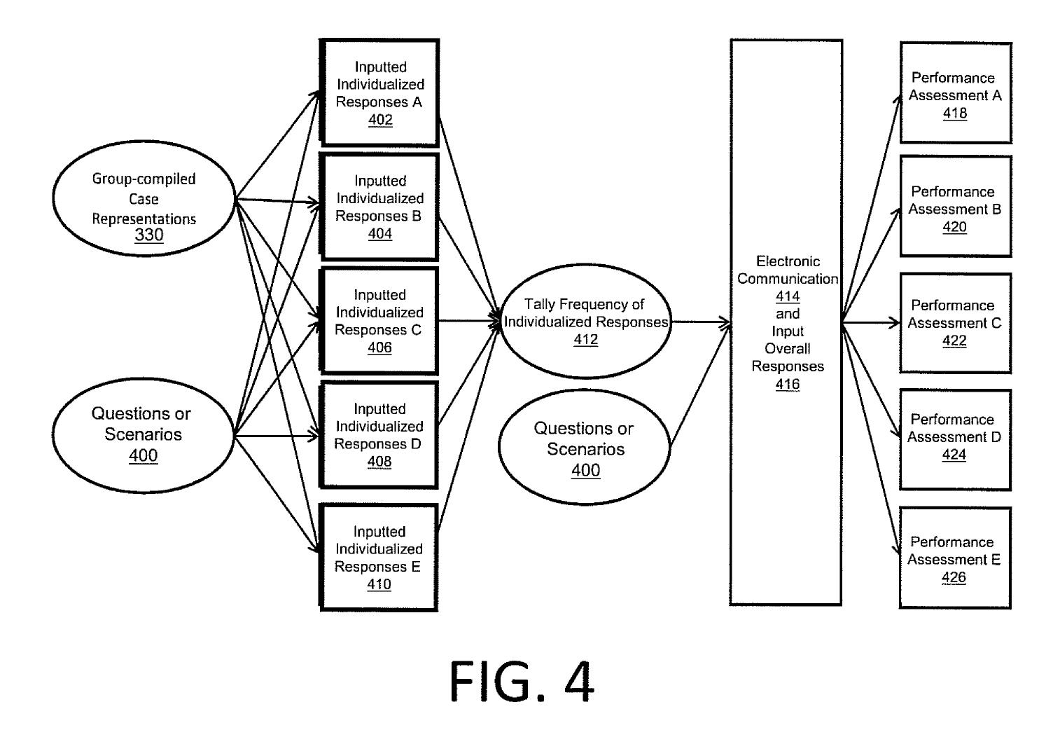

By assessing the individualized responses and overall responses of the group, the method 200 may assess the performance of each of the group members and the group as a whole. In an exemplary embodiment, the performance of the groups and group members may be assessed based on the scoring of the performance of each of the group members obtained from each of the other group members in their respective groups. In addition, assessment of the individualized responses may include tallying the frequency of each of the individual responses. See FIG. 4 for a more detailed discussion.

At block 2700, progress reports of the group members are distributed to the instructor, one or more of the group members, and/or any user with access to network of computers 100 in order to track the progress and activity of each of the group members and the groups as a whole. By way of example and not limitation, the progress reports may include the assessment of the individualized responses, the activity with respect to the number of attempts to access the project or problem (i.e., the number of logins into the network of computers or computer), and the activity with respect to participation in the collaborative discussion. The participation in the discussion of each the group members may be tracked based on the number posts and replies to a message board by the group members, and number of views of the message board posts by the group members.

As indicated by the arrow 2800, all of the steps of the method 200 may be repeated as a cycle with the team. This repetition of a step or group of steps may be done at any time or at certain milestones of the problem or project, which may be, for example, determined and scheduled by the instructor or a group member. In one exemplary embodiment, the step of distributing progress reports of the group members 2700 is preferably not repeated as part of the cycle, but rather any and all of the steps 2000 through 2600 are repeated. Thus, the activity of the groups and/or group members may be tracked over a number of projects or problems and/or the numerous milestones of the problem or project. As discussed above with respective to FIG. 1, all the steps of the method 200 may be accomplished via a network of computers or a computer over any extended period of time and without the need of support or involvement from an instructor, proctor, or coordinator during the implementation of any or all the steps.

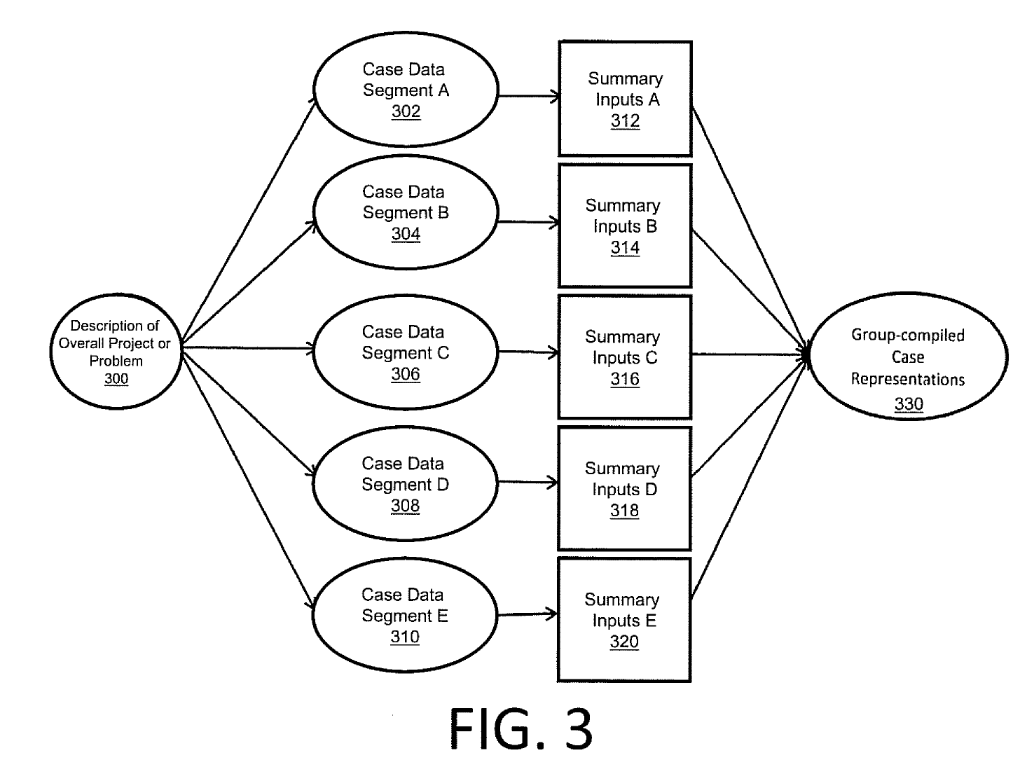

FIG. 3 provides a more detailed illustration of blocks 2000, 2100 and 2300 of the method 200 illustrated in FIG. 2. A description of an overall project or problem 300 is divided into role specific information, which is particular to each of the groups. The role specific information is represented as case data segments (A-E) 302, 304, 306, 308, 310. The case data segments 302, 304, 306, 308, 310 are different from each other and correspond to the number of groups on the team. Each of the case data segments 302, 304, 306, 308, 310 is distributed to each of the respective groups based on the assigned role of the group on the team.

The role specific information is summarized by the one or more group members in each of the groups into summary inputs (A-E) 312, 314, 316, 318, 320. While each of the groups summary inputs are shown collectively, it is understood the each of group members is permitted to input a summary input of the role specific information. The summary inputs 312, 314, 316, 318, 320 are then compiled into group-compiled case representations 330, which may be used by each of the group members as reference throughout the cycle. However, the role specific information provided to each of the groups preferably may not be shared with the other groups or stored for later use unless it is summarized as a summary input.

Referring to FIG. 4, a more detailed illustration of blocks 2200, 2400, 2500, and 2600 of the method 200 illustrated in FIG. 2 is provided. The group-compiled case representations 330, which is a collection of all the summaries of the role specific information, and the questions or scenarios 400 are distributed to each of the group members. With use of group-compiled case representations 330, each of the group members inputs responses to each of the questions or scenarios on an individual basis. The inputted responses by way of example are depicted as inputted individualized responses A-E 402, 404, 406, 408, 410. However, the number of inputted responses would correspond to the number of group members of all the groups.

The inputted individualized responses 402, 404, 406, 408, 410 may be assessed and a frequency of each of the responses inputted may be tallied 412 for purposes of initiating a collaborative discussion among the groups. In an exemplary embodiment, the server computer 1100 performs the tallying step 412 as part of the assessment of the individualized responses. In another exemplary embodiment, the server computer 1100 outputs and displays the tallied frequency of each the individualized responses to each the groups via the web-based interface 1302, 1402, 1502.

The collaborative discussion among the groups may be facilitated by electronic communications 414 transmitted over the network of computers 100 between each group members of the different groups. The groups are distributed the same questions or scenarios 400 to be which each of the group members formulated individualized responses. The purpose of the collaborative discussion is for all the groups to communicate with each other in order to formulate overall responses 416 as a team to the questions or scenarios 400. By way of example and not limitation, the overall responses 416 are inputted to the server computer 1100 on behalf of all the groups.

Upon completion of the collaborative responses, the assessment of the group members and the groups includes performance assessments A-E 418, 420, 422, 424, 426. As detailed above with respect to block 2600 depicted in FIG. 2, such an assessment may include, for example, comparison of the inputted individualized responses and overall responses with stored responses. In another exemplary embodiment, the assessing step includes each of the group members scoring the other groups members of all the groups on each of her or his performance on the team. For example, the performance assessments A-E 418, 420, 422, 424, 426 may be inputted by each of the group members into the server computer 1100 for purposes of tracking the progress of each the group members.

FIG. 5 is a block diagram illustrating a conventional computer system 500 within which a set of instructions, for causing the machine to perform any one or more of the methodologies and operations discussed herein, may be executed. Computer system 500 includes a bus 502 or other communication mechanism for communicating information, and a processor or processors 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The pertinent programs and executable code is contained in main memory 506 and is selectively accessed and executed in response to processor 504, which executes one or more sequences of one or more instructions contained in main memory 506. Such instructions may be read into main memory 506 from another computer-readable medium, such as storage device 510. One or more processors in a multi-processing arrangement may also be employed to execute the sequences of instructions contained in main memory 506. In alternative embodiments, hard-wired circuitry may be used in place of or in combination with software instructions and it is to be understood that no specific combination of hardware circuitry and software are required.

The instructions may be provided in any number of forms such as source code, assembly code, object code, machine language, compressed or encrypted versions of the foregoing, and any and all equivalents thereof. “Computer-readable medium” refers to any medium that participates in providing instructions to processor 504 for execution and “program product” refers to such a computer-readable medium bearing a computer-executable program. The computer usable medium may be referred to as “bearing” the instructions, which encompass all ways in which instructions are associated with a computer usable medium. The present invention may be a system, a method, and/or a computer program product. The computer program product may include a computer readable storage medium (or media) having computer readable program instructions thereon for causing a processor 504 to carry out aspects of the present invention.

Computer-readable mediums include, but are not limited to, non-volatile media, volatile media, and transmission media. Non-volatile media include, for example, optical or magnetic disks, such as storage device 510. Volatile media include dynamic memory, such as main memory 506. Transmission media include coaxial cables, copper wire and fiber optics, including the wires that comprise bus 502. Transmission media may comprise acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be borne on a magnetic disk of a remote computer. The remote computer can load the instructions into its dynamic memory and send the instructions over a telephone line using a modem. A modern local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 404.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor 504 of the computer system 500 or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer system 500, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer system 500 may also include a communication interface 518 coupled to bus 502 to provide a two-way data communication coupling to a network link 520 connected to a local network. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks 1000 to other data devices. For example, network link 520 may provide a connection through local network to a host computer or to data equipment operated by an Internet Service Provider (ISP). ISP in turn provides data communication services through the worldwide packet data communication network, now commonly referred to as the “Internet.” Local network and Internet both use electrical, electromagnetic or optical signals that carry digital data streams. The signals through the various networks and the signals on network link 520 and through communication interface 518, which carry the digital data to and from computer system 500, are exemplary forms of carrier waves transporting the information. Thus, the processing required by methods of the invention described by way of example herein may be implemented on a local computer utilizing storage device 510 or may be implemented, for example, on a LAN or over the internet.

Computer system 500 can send messages and receive data, including program code, through the network(s) 1000, network link 520, and communication interface 518. In the Internet example, a server might transmit a requested code for an application program through Internet, ISP, local network and communication interface 518. The received code may be executed by processor 404 as it is received, and/or stored in storage device 510, or other non-volatile storage for later execution. In this manner, computer system 500 may obtain application code in the form of a carrier wave.

### EXAMPLE 1

Experimental Testing

The computer implemented methods, systems and products described above were put into practice as an experiment with 529 senior students at a university level from a variety of disciplines, including medicine, nursing, pharmacy, and social work. The students participated in a four-unit, six-week trial of the case system. The overall project and questions focused on geriatric care. The following methodologies and resulting data are provided as an example and by no means limit the implementation and/or application of the computer implemented methods, systems and products detailed above in the figures.

During the 2012-2013 academic year, all enrolled fourth year students in medicine and nursing (BSN programs), some volunteer fourth year pharmacy students, and all second year masters students in social work in the clinical practice concentration were placed in teams of 4-9 groups for one of four sequential six-week blocks (two blocks in each semester). All professions were represented on each team for every block with the exception of the fourth block during which pharmacy students were unavailable to participate in the project.

During each six-week block, teams completed four distinct units of about ten days duration. Each unit represented one turn through the cycle of the learning method. The final deadline for each unit (i.e., deadline for submission of overall responses and/or performance assessments) was set by an instructor. Teams were encouraged to set intermediate deadlines for other task work (e.g., inputting individual responses).

Informal feedback from students noted dissatisfaction with the unstructured nature of the teams' function. Faculty also noted that students generally did not bring to the exercise an innate ability to form highly effective teams, despite many hours of exposure to team-based environments in more traditional venues of clinical training (i.e., hospital wards, out-patient clinics). In response to this concern, during the second half of the academic year (blocks three and four), a charter exercise was added to the orientation to facilitate establishing team roles, responsibilities, and communication protocols. In addition, or the next academic year, an additional hour was added to the orientation session.

All other group activities were structured and led entirely by the group members. Each team also had a faculty preceptor (e.g., an instructor) from the case authoring group. The faculty preceptor observed activity on the computer implemented system and provided occasional feedback regarding team function within the project. However, in order to sustain group autonomy, the faculty preceptor did not provide any insight into responses of questions.

The computer implemented methods, systems, and products provided a platform to bring together health professional students from four professions to work as a team. The students actively engaged with the EHR interface and message board to enter case information and answer case-related questions. This process mirrored the asynchronous coordination of care, common in non-urgent clinical work. In addition, the virtual case system overcame the logistical difficulties inherent in providing an interprofessional educational experience to a large number of students including assessment of both individual and team performance.

In addition, the computer implemented methods, systems and products provides a platform to teach and assess interprofessional practice in a setting similar to current practice. Through a web-based interface similar to an EHR, group members worked together to make care decisions for a patient across several environments of care. The computer implemented method, systems and products provided useful data about group member and team performance that could be used for assessment of competency. This approach to education could be used to train the behaviors needed to overcome the challenges facing healthcare.

While students generally performed well on the project, some individuals participated less actively as other group members. Non-participation may also be a signal for students who lack the collaborative attitudes necessary in modern healthcare.

The outputs of the computer implemented methods, systems, and products provide a new approach to student assessment. Scores on knowledge items correlated with activity measures, suggesting weaker scores signified less engaged team members. Approaches like the present invention provide an opportunity to track teamwork behaviors in a fashion previously limited to direct faculty observation or video review of encounters. Further efforts to correlate behaviors with scalable outcomes (e.g. individual or team score, post views) could add a powerful new tool to the assessment of students, particularly for members of a team project. Although student evaluations were strictly formative during the year of study, each school is moving to a minimum passing threshold for performance in subsequent years that is a combination of individual score and preceptor evaluations.

In the exemplary experiment, preceptor observations and review of response data identified gaps in geriatric education within our schools. This information may be used to improve geriatric curricula across all schools. In addition, response data could also allow for tailored review of individual participants in order to identify specific knowledge deficits. It should also be noted that, although social work scores were lower than the scores of other students from other health professions, this finding is primarily attributable to the relative lack of questions focused on competencies for social work students. For example, the computer implemented method provided a novel opportunity for faculty to discuss student performance and develop a common understanding of how to teach concepts of interprofessional care across professions. By further example, the contributions from the students created a rich database for future study.

Methods

The architecture of the computer implemented learning method was divided into a five step learning cycle. First, each group received patient information, specific to their professional role. This information represented the clinical data that profession might obtain about a patient either through clinical interaction or other repositories of information (e.g., prescription fill records for a pharmacist). Second, each group member summarized the patient information into the EHRs in a process similar to documenting within a clinical record.

Third, each group member answered questions individually related to the patient's case. Group members had access to the EHR entries of the other team members, and the questions were designed to require extracting information that had been entered into the EHR by other team members. The questions also targeted the expertise of different professions (i.e., a physician or medical student would have difficulty answering a question requiring social work expertise if they did not seek assistance from the social work student on their team). Links to helpful resources were provided to the group members.

Fourth, the groups worked as a team to respond to the same questions that they had answered as individuals. To facilitate asynchronous coordinative behavior, the computer implemented system contained an electronic message board, but the group members were allowed to work in any fashion they chose, including meeting face-to-face. Message board functionality included the ability to start threads on different topics and reply to the posts of others. Fifth, group members completed performance assessments of their peers.

The computer implemented system was developed as a web-based application so that group members, preceptors and administrators could interact with the system from anywhere with access to a network. While in the following example the user interfaces for group members, preceptors and administrators were developed in Adobe Flash™ using ActionScript™ 3.0 and included a web-based application framework developed in Microsoft C# .NET™ 3.5 that in turn inputted and outputted data from a Microsoft™ SQL Server 2008 relational database, implementation and development of the present invention may be accomplished by any similar applications or structures. Administrative and preceptor interfaces (i.e., instructor computer's web-based interface) were designed to allow for dynamic modification of descriptions of overall projects or problems (e.g., clinical information on the patient), questions or scenarios for each unit, debriefing information that followed each turn through the learning cycle, and the length of each learning cycle. Login and access functions for both group members and preceptors were controlled through a password protected interface that defined allowed user functions.

Case Content

The initial case content was focused on geriatric care and followed an older female over seven years of life as she transitioned between the settings of primary care, hospital, sub-acute nursing facility, and hospice. An interprofessional team of faculty drafted the case content and questions for each unit. This team included faculty from medicine, nursing, pharmacy, social work, occupational therapy, and gerontology. The distributed description provided to group members from each profession was distinct and intentionally included inconsistencies. For example, pharmacy students received the list of medications recently filled from the pharmacy, nursing students received the list of medications brought to the clinic visit, medical students received a record of medication recently prescribed in the EHR, and social work students received the list of medications noted on a recent home visit). Questions and case content were driven by the Association of American Medical College's geriatric competencies for medical students. Questions ranged from basic science principles (e.g., physiologic changes with aging) to care decisions for the patient in the project to legal and ethical principles of care.

A multiple response question format was utilized to reduce the impact of chance on performance and provide a format more representative of actual patient management decisions than standard multiple choice questions afford. Each question had multiple answer choices for which the group members or team had to decide whether each choice was correct or incorrect. The faculty team assigned each answer choice a point value ranging from +5 for the most appropriate answers to −5 for the least appropriate answers. Appropriateness was defined by the necessity to the patient's clinical situation and included consideration of cost. Answers in between the extremes of appropriateness could have been assigned point values of −3, −1, +1, or +3. Each question also included an answer choice of “Outside my profession's usual practice,” which was worth 0 points. Group members were instructed to choose this choice only as a last resort and were encouraged to use external resources instead of selecting this option. To compute a score for each individual or team, all point values were summed and multiplied by ten. The range of possible final scores was from −9500 to 9200.

Assessment of Student, Team, and Case System Performance

Integrated in the computer implemented method's design was the ability to track in order to provide progress reports of each group member's activity by the number of logins, EHR entries, message board posts and replies, and views of message board posts. In addition, responses on the questions at the individual and team level were compared to the appropriate answers and corresponding scores were calculated.

Descriptive statistics and bivariate correlations were calculated for scores and for activity measures by individual group member, by team, and by profession. Individual scores were compared across professions. Case activity measures were then tested as predictors for individual score and for team score using multiple linear regression and multilevel modeling. Multilevel modeling was used to account for correlations within groups and to assess the relationship between individual performance measures and team score.

Results

Participation

Through the entire academic year, 80 teams composed of 529 students completed the case experience. Teams ranged in size from four to nine group members, with seven being the median number of group members per team. By school, the number of participants was: 197 from medicine, 146 from nursing, 62 from pharmacy, and 124 from social work. A summary of case activity measures is provided in Table 1. For the entire experience, students reported an average of 0.64 face-to-face meetings (range: 0-2), meaning most work was completed asynchronously.

TABLE 1

| Case activity | Overall | Average per | Median by | Range by |
|---|---|---|---|---|
| measures | number | student | team | team |
| Logins | 14,468 | 27.7 | 172.5 | 68-470 |
| EHR entries | 6,231 | 12.6 | 74.5 | 29-178 |
| Message board posts | 8,587 | 18.3 | 65.0 | 0-2265 |
| and replies | | | | |
| Message board posts | 30,286 | 64.7 | 267.0 | 0-175 |
| viewed | | | | |

Scores

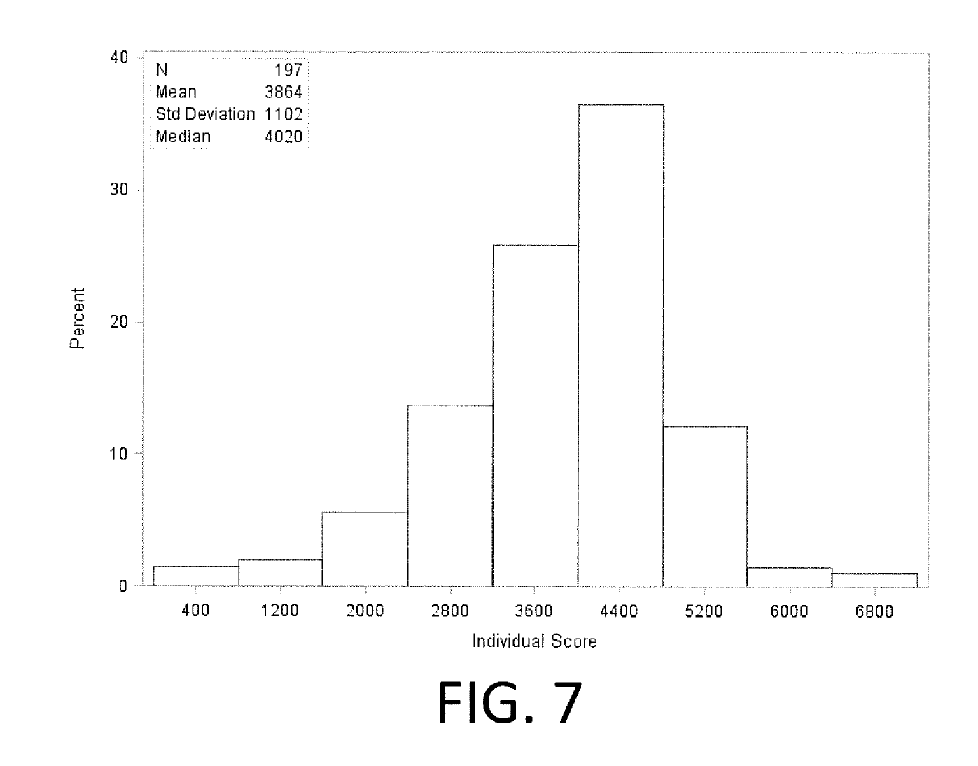

FIG. 6 shows the distribution of individual scores on the questions supplied to the groups from a testing experiment of the present invention. In particular, FIG. 6 shows that the individual scores ranged from −440 to 6920 and varied by profession. Medical students scored the highest (M=3864, SD=1102) followed by nursing students (M=3470, SD=825) and pharmacy students (M=3020, SD=1358) (p=NS for all comparisons by independent t-test). Scores for social work students (M=1433, SD=916) were significantly lower than the other three professions (p<0.001). Examination of scores within each profession revealed patterns of stronger and weaker performance. For example, a histogram of scores by medical students showed a small group of students with significantly lower scores, as illustrated by FIG. 7.

Team scores on the same questions ranged from 2630 to 6530. Median and average team scores were higher than the individual scores for any profession and showed a narrower range.

Correlations Between Activity Variables and Scores

Individual scores were significantly correlated with all activity measures (e.g., number of logins, EHR entries, message board posts and replies, and views of message board posts) with moderate r-values ranging from 0.30 to 0.37 (p<0.001). Team scores were significantly correlated with logins (r=0.42, p<0.001), message board posts and replies (r=0.46, p<0.001), and message board posts viewed (r=0.46, p<0.001), but team scores were not correlated with EHR entries (p=0.13). The effect sizes for the significant correlations were slightly larger than the comparable effect sizes for the correlations between each activity measure and individual scores.

Multiple linear regression analysis was used to test the unique influence of each activity measure on individual scores and on team scores. Activity measures for individuals explained 17% of the variance in individual scores (R²_{adj}=0.17, F_{4,443}=24.3, p<0.001). However, only two of the individual measures were significant positive predictors of individual scores EHR entries (B=27.7, p<0.001) and message board posts and replies (B=12.9, p=0.002). Logins and message board posts viewed did not appear to be significant predictors in the exemplary model. When activity measures by team were regressed on team scores, the exemplary model was also statistically significant with an adjusted R² value of 0.20. Among the activity measures, a statistically significant predictor for team score was each student's number of message board posts and replies.

### EXAMPLE 2

The application of the present invention is not limited to a health care setting or health professions education but is applicable to education or training in any setting where collaboration and coordination within a team is important. For example, the present invention may assist in the construction setting. This invention may be used to train teams of engineers, architects, and/or group managers to organize and to work together on a construction project. Implementation of the present invention allows for the assessment of how the overall group plans and implements a construction project while also providing individualized assessments of the abilities of each group member.

As a further example, the present invention may also be applicable to a corporate setting. A company, which is seeking to have various employees from different departments work together on a problem or project, may utilize and implement this invention to assess each employee's collaborative abilities, to train collaborative behaviors, and to measure the likelihood of a team's success to achieve a successful outcome on the project or problem. By way of example and not limitation, if a company sought to develop and market a new product, the company may utilize the present invention to examine the work of teams of employees from the research, advertising, financing and other departments, to identify the best team and team members for a task, potentially affording an opportunity to generate new insights into how to solve a complex problem.

As another example, the present invention may be used to train military teams. Different platoon members (e.g., leader, communications, medic, infantry) may be provided individual information based on a role and have to collaborate effectively to navigate a complex scenario. Performance in the exercise may assess leadership abilities, communication patterns, and other critical team attributes at both the individual and team levels. A similar approach may be applicable with law enforcement, homeland security, and any other similar group.

As an additional example, the present invention is also applicable for training teams in healthcare beyond the described example of students, presented as Example 1 above. Healthcare teams that operate in close proximity, such as the operating room or emergency department, and teams that are not co-located, such as teams in primary care and home health care, may be trained by the present invention to assess collaborative abilities at the individual and team levels and develop better processes and/or procedures for communication within a controlled environment. Accordingly, the present invention is applicable to any setting requiring learning or working in teams and may be utilized by any leader and/or educator who need a method, system or product to train and assess these abilities.

Various embodiments disclosed herein are described as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to the provided description without departing from the scope or spirit of the disclosure.

What is claimed is:

1. A computer implemented method for team based learning with individual and group assessment for addressing a project or a problem, comprising the steps of:
providing, using a computer or network of computers, a description of an overall project or problem to a plurality of groups, each of said groups including one or more group members, and each of said groups having a role for said overall project or problem wherein said role is different for each of said groups;
distributing, using said computer or network of computers, different role specific information to each of said groups;
distributing, using said computer or network of computers, questions or scenarios to each of said groups, said questions or scenarios pertaining to said role specific information and to said overall project or problem;
permitting said one or more group members in each of said plurality of groups to input to an electronically accessible repository one or more summary inputs of said role specific information provided to said group;
obtaining, using said computer or network of computers, inputted individualized responses to said questions or scenarios from each of said group members of each of said groups;
obtaining, using said computer or network of computers, inputted overall responses to said questions or scenarios, said inputted overall responses being supplied on behalf of said plurality of groups; and
assessing, using said computer or network of computers, said inputted individualized responses and said inputted overall responses.

2. The computer implemented method of claim 1, wherein said step of assessing compares one or more inputted overall responses to one or more stored responses to said questions or scenarios.

3. The computer implemented method of claim 1, wherein said step of assessing compares one or more inputted individualized responses to one or more stored responses to said questions or scenarios.

4. The computer implemented method of claim 1 further comprising the steps of:
permitting electronic communications between each of said groups;
saving said electronic communications; and
evaluating said electronic communications using said computer or network of computers.

5. The computer implemented method of claim 1 further comprising, at one or more milestones, the steps of:
repeating one or more of distributing different role specific information to each of said groups or distributing questions or scenarios to each of said groups; and
repeating each of obtaining inputted individualized response, obtaining inputted overall responses, and assessing said inputted individualized responses and said inputted overall responses.

6. The computer implemented method of claim 5 further comprising the step of:
comparing inputted individualized responses to inputted overall responses.

7. The computer implemented method of claim 6, wherein said step of comparing is performed multiple times.

8. The computer implemented method of claim 1 further comprising the step of:
preventing sharing of said different role specific information on said electronically accessible repository or by electronic transmission without being summarized as said one or more summary inputs.

9. The computer implemented method of claim 1 further comprising the step of:
distributing, using said computer or network of computers, progress reports of the one or more group members.

10. The computer implemented method of claim 1, wherein said step of assessing obtains performance assessments of the one or more group members.

11. The computer implemented method of claim 1, wherein said step of assessing tallies a frequency of each of the inputted individual responses.

12. A computer program product for team based learning with individual and group assessment for addressing a project or a problem, the computer program product comprising a computer readable storage medium having program instructions embodied therewith, the program instructions executable by a processor to cause the processor to perform a method comprising the steps of:
providing a description of an overall project or problem to a plurality of groups, each of said groups including one or more group members, and each of said groups having a role for said overall project or problem wherein said role is different for each of said groups;
distributing different role specific information to each of said groups;
distributing questions or scenarios to each of said groups, said questions or scenarios pertaining to said role specific information and to said overall project or problem;
permitting said one or more group members in each of said plurality of groups to input to an electronically accessible repository one or more summary inputs of said role specific information provided to said group;
obtaining inputted individualized responses to said questions or scenarios from each of said group members of each of said groups;
obtaining inputted overall responses to said questions or scenarios, said inputted overall responses being supplied on behalf of said plurality of groups; and
assessing said inputted individualized responses and said inputted overall responses.

13. The computer program product of claim 12, wherein said step of assessing compares one or more inputted overall responses to one or more stored responses to said questions or scenarios.

14. The computer program product of claim 12, wherein said step of assessing compares one or more inputted individualized responses to one or more stored responses to said questions or scenarios.

15. The computer program product of claim 12 further comprising the steps of:
permitting electronic communications between each of said groups;
saving said electronic communications; and
evaluating said electronic communications.

16. The computer program product of claim 12 further comprising, at one or more milestones, the steps of:
repeating one or more of distributing different role specific information to each of said groups or distributing questions or scenarios to each of said groups; and
repeating each of obtaining inputted individualized response, obtaining inputted overall responses, and assessing said inputted individualized responses and said inputted overall responses.

17. The computer program product of claim 16 further comprising the step of:
comparing inputted individualized responses to inputted overall responses.

18. The computer program product of claim 17, wherein said step of comparing is performed multiple times.

19. The computer program product of claim 12 further comprising the step of:
preventing sharing of said different role specific information on said electronically accessible repository or by electronic transmission without being summarized as said one or more summary inputs.

20. The computer program product of claim 12 further comprising the step of:
distributing progress reports of the one or more group members.

21. The computer program product of claim 12, wherein said step of assessing obtains performance assessments of the one or more group members.

22. The computer program product of claim 12, wherein said step of assessing tallies a frequency of each of the inputted individual response.
